(19) United States
(12) Patent Application Publication
(10) Pub. No.: US 2018/0302527 A1
(43) Pub. Date: Oct. 18, 2018

(54) IMAGE FORMING APPARATUS

(71) Applicants: KABUSHIKI KAISHA TOSHIBA, Tokyo (JP); TOSHIBA TEC KABUSHIKI KAISHA, Tokyo (JP)

(72) Inventor: Akitoshi SUZUKI, Mishima (JP)

(73) Assignees: KABUSHIKI KAISHA TOSHIBA, Tokyo (JP); TOSHIBA TEC KABUSHIKI KAISHA, Tokyo (JP)

(21) Appl. No.: 15/706,390

(22) Filed: Sep. 15, 2017

(30) Foreign Application Priority Data
Apr. 18, 2017 (JP) 2017-082161

(51) Int. Cl. H04N 1/053; H04N 1/00

(52) U.S. Cl. CPC H04N 1/053; H04N 1/00037; H04N 1/00702

(57) ABSTRACT

In accordance with an embodiment, an image forming apparatus comprises a sensor and a controller. The sensor detects a Light for scanning a scanning area to synchronize a main scanning direction in the scanning area. The controller corrects a deviation amount of the main scanning direction by setting a print termination position of the light in the main scanning direction as a reference position based on a detection result of the sensor.

### CROSS-REFERENCE TO RELATED APPLICATION

This application is based upon and claims the benefit of priority from Japanese Patent application No. 2017-082161, filed Apr. 18, 2017, the entire contents of which are incorporated herein by reference.

### FIELD

Embodiments described herein relate generally to an image forming apparatus.

### BACKGROUND

The image forming apparatus forms an image on a sheet while conveying a sheet-like image receiving medium (hereinafter, collectively referred to as a “sheet”) such as a paper.

At the time of forming an image on the sheet, the image forming apparatus forms a scanning line by scanning a scanning area on a photoconductive drum with a laser beam in a main scanning direction. The scanning line includes a plurality of signals (hereinafter, referred to as “dots”) of pixel units. By scanning the scanning area with the laser beam, a plurality of dots is formed in the main scanning direction. If an arrangement position of the dot deviates from a reference position, a transfer position. deviation of the image on. the sheet may occur. In order to prevent the transfer position deviation, it is necessary to adjust the arrangement position of the dot to an appropriate position. However, it costs much time to adjust the arrangement position of the dot to the appropriate position.

### DESCRIPTION OF THE DRAWINGS

FIG. 1 is a schematic view illustrating an example of an internal constitution of an image forming apparatus according to one embodiment;

FIG. 2 is a diagram illustrating an example of a schematic constitution of an image forming apparatus according to one embodiment;

FIG. 3 is a plan view illustrating an example of a schematic constitution of an exposure section according to one embodiment;

FIG. 4 is a side view illustrating an example of a schematic constitution of an exposure section according to one embodiment;

FIG. 5 is a block diagram illustrating an example of functional components of an image forming apparatus according to one embodiment;

FIG. 6 is a flowchart illustrating an example of a correction control of a deviation amount according to one embodiment;

FIG. 7 is a diagram illustrating an example of a scanning area before a main scanning magnification is changed;

FIG. 8 is a diagram illustrating an example of a scanning area after a main scanning magnification is enlarged;

FIG. 9 is a diagram illustrating an example of a scanning area after a main scanning magnification is reduced;

FIG. 10 is a diagram illustrating an example of a correction control of a deviation amount after a main scanning magnification is enlarged;

FIG. 11 is a diagram illustrating an example of a correction. control of a deviation amount after a main scanning magnification is reduced;

FIG. 12 is a diagram illustrating an example of a scanning area after a correction control of a deviation amount;

FIG. 13 is diagram illustrating an example of a transfer position deviation of an image on a sheet after a main scanning magnification is enlarged;

FIG. 14 is diagram illustrating an example of a transfer position deviation of an image on a sheet after a main scanning magnification is reduced; and

FIG. 15 is diagram illustrating an example of an image on a sheet after a correction control of a deviation amount.

### DETAILED DESCRIPTION

In accordance with an embodiment, an image forming apparatus comprises a sensor and a controller. The sensor detects a light for scanning a scanning area to synchronize a main scanning direction in the scanning area. The controller corrects a deviation amount of the main scanning direction by setting a launch termination position of the light in the main scanning direction as a reference position based on a detection result of the sensor.

Hereinafter, an image forming apparatus of an embodiment is described with reference to the accompanying drawings. Furthermore, in each diagram, the same component is donated with the same reference numeral.

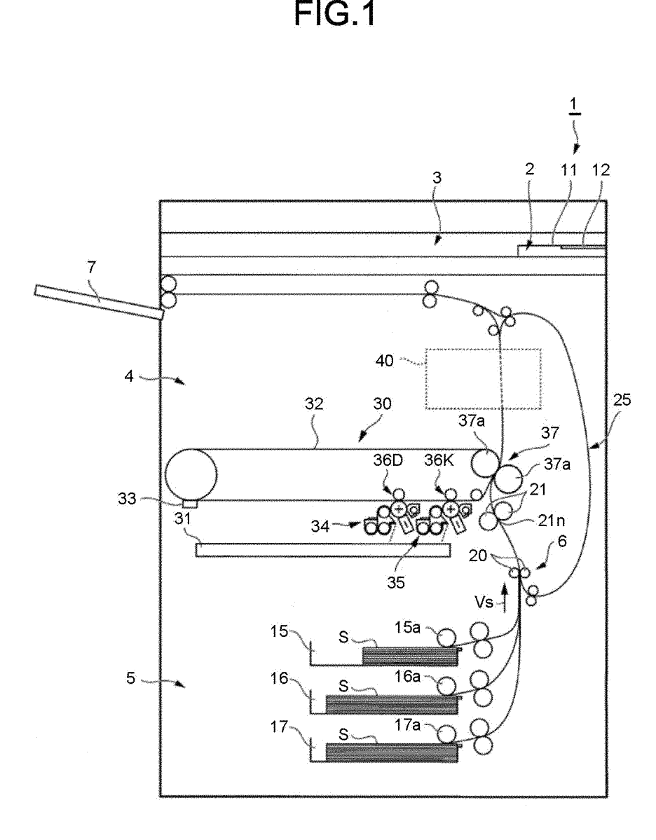

FIG. 1 is a schematic view illustrating an example of an internal constitution of an image forming apparatus 1 according to an embodiment. For example, the image forming apparatus 1 is an MFP (multi-function peripheral). The image forming apparatus 1 reads an image formed on a sheet to generate digital data (image file). The image forming apparatus 1 forms an image on the sheet using a toner based on the digital data. For example, the sheet is a paper or a film. The sheet may be any material as long as the image forming apparatus 1 can form an image on the surface of the sheet.

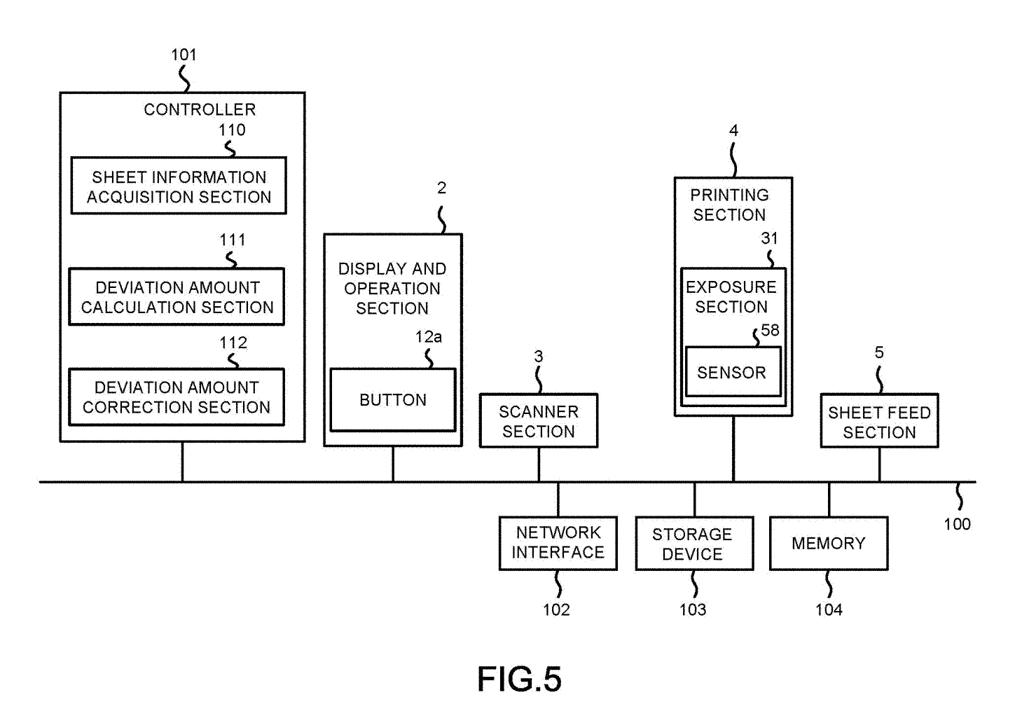

The image forming apparatus 1 includes an operation and display section 2, a scanner section 3, a printing section 4, a sheet feed section 5, a conveyance section 6, a sheet discharge section 7 and a controller 101 (refer to FIG. 5).

The operation and display section 2 is provided with a display section 11 and an operation section 12

The display section 11 operates as an output interface to display characters and images For example, the display section. 11 is a display device such as a liquid crystal display and an organic EL (Electro Luminescence) display. The display section 11 displays various information relating to the image forming apparatus 1.

The operation section 12 operates as an input interface to receive instructions from a user. For example, the operation section 12 includes a plurality of buttons and the like. The operation section 12 receives an operation by the user on a plurality of buttons. The display section 11 and the operation section 12 may integrally form a touch panel. For example, the operation and display section 2 may be a touch panel type liquid crystal display. The operation and display section 2 may operate as an output interface and as an input interface.

The scanner section 3 reads image information of an object to be read in a scan mode. For example, the scanner section 3 is a CIS (Contact Image Sensor), a CCD (Charge Coupled Devices) or the like. The scanner section 3 uses a sensor to read an image formed on the sheet to generate the digital data.

The printing section 4 forms an image on a front surface of the sheet based on the image data generated by the scanner section 3 in a copy mode. The printing section 4 forms an image on the sheet using the toner. The printing section 4 forms an image based on image data read by the scanner section 3 or image data received from an external device. For example, the image formed on the sheet is an output image called a hard copy or a printout. Alternatively, the printing section 4 forms an image on the front surface of the sheet based on the image data received from another information processing apparatus via a network.

The sheet feed section 5 supplies the sheet used in image output to the printing section 4. The sheet feed section 5 supplies sheets one by one to the printing section 4 according to a timing at which the printing section 4 forms a toner image. The sheet feed section 5 is provided with a plurality of sheet feed cassettes 15, 16 and 17. Each of the sheet feed cassettes 15, 16 and 17 houses a sheet having preset size and type.

The sheet feed cassettes 15, 16 and 17 have pickup rollers 15a, 16a and 17a, respectively. The pickup rollers 15a, 16a and 17a pick up the sheets one by one from the sheet feed cassettes 15, 16 and 17, respectively. The pickup rollers 15a, 16a and 17a supply the picked sheets to the conveyance section 6.

At least one of the plural sheet feed cassettes 15, 16 and 17 houses a sheet before decoloring to be fed in a decoloring mode. On the sheet before decoloring, an image is formed by a decolorable toner. The sheet before decoloring may be fed from a manual sheet feed section (not shown).

At least one of the plurality of the sheet feed cassettes 15, 16 and 17 may house a sheet on which an image forming operation using the decolorable toner is executed. For example, the sheet on which the image forming operation using the decolorable toner is executed may be a sheet of which the decoloring is completed in the decoloring mode. By executing the image forming operation with the decolorable toner again. on the sheet of which the decoloring is completed, it is possible to reuse the sheet a plurality of times.

The conveyance section 6 conveys the sheet in the printing section 4 and the sheet feed section 5. In the following description, as the sheet is conveyed from the sheet feed section 5 to the sheet discharge section 7, a sheet feed section 5 side is set to an upstream side in a sheet conveyance direction Vs, and a sheet discharge section 7 side is set to a downstream side in the sheet conveyance direction Vs.

The conveyance section 6 includes a pair of conveyance rollers 20 and a pair of resist rollers 21.

The conveyance roller 20 conveys the sheet supplied from the pickup rollers 15a, 16a and 17a to the resist roller 21.

The resist rollers 21 temporarily stop the sheet conveyed from the conveyance roller 20. The resist rollers 21 send the sheet out towards a secondary transfer section 37 in accordance with a timing at which the toner image formed on an intermediate transfer body 32 is transferred by the secondary transfer section 37. The resist rollers 21 face each other across a conveyance path between the conveyance roller 20 and the secondary transfer section 37. Between the pair of the resist rollers 21, a nip 21n is formed.

The conveyance roller 20 enables a downstream end of the sheet to abut against the nip 21n of the resist roller 21. The conveyance roller 20 aligns a position of the downstream end of the sheet by bending the sheet. The resist roller 21 conveys the sheet to the secondary transfer section 37 side after the downstream end of the sheet sent from the conveyance roller 20 is aligned at the nip 21n.

In FIG. 1, a reference numeral 25 represents an inversion unit.

The inversion unit 25 inverts the sheet discharged from a fixing section 40 by switchback operation. The inversion unit 25 conveys the inverted sheet to the front of the resist roller 21 again. The inversion unit 25 inverts the sheet to forma toner image on aback surface of the sheet on which a fixing processing is executed.

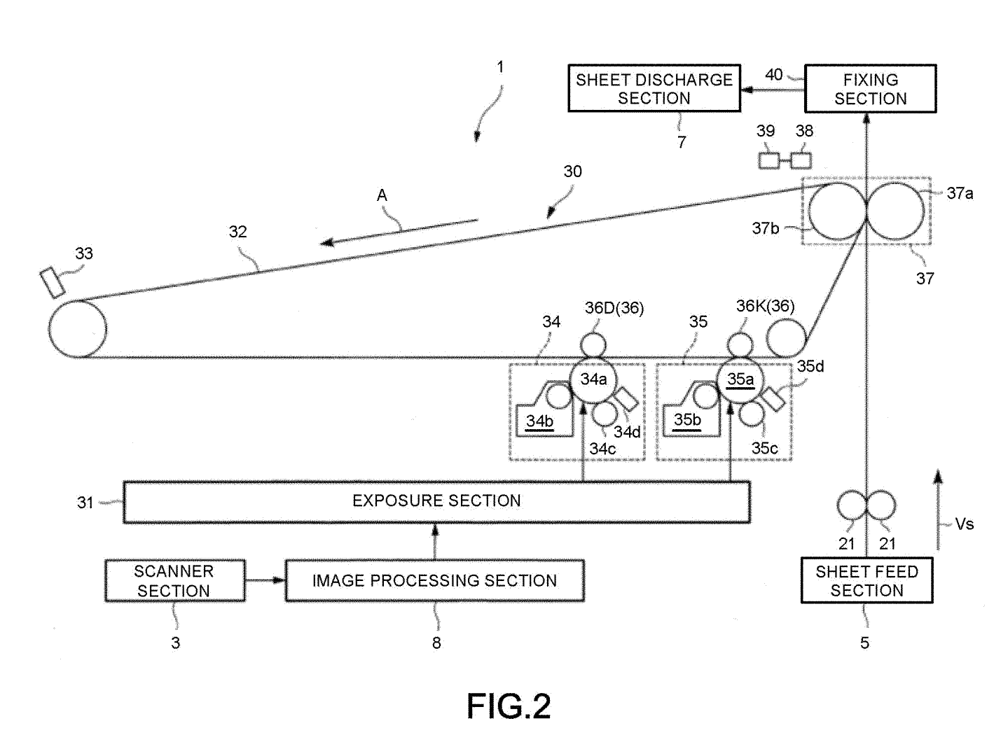

FIG. 2 is a diagram illustrating an example of a schematic constitution of the image forming apparatus 1 according to one embodiment. The image forming apparatus 1 is an image forming apparatus of an electrophotographic system. The image forming apparatus 1 is a two-tandem type image forming apparatus.

As examples of the toner, the decolorable toner, a non-decolorable toner (normal toner), a decorative toner and the like are exemplified. The decolorable toner has a property of decoloring by external stimuli. The “decoloring” refers to making an image formed with a color (including not only a chromatic color but also an achromatic color such as white and black) different from a color of a ground of the sheet visually invisible. For example, the external stimulus includes temperature, light, of a specific wavelength and pressure. In one embodiment, the decolorable toner is decolorized at a prescribed decoloring temperature or more. The decolorable toner develops color at a prescribed restoring temperature or less after decoloring.

Any toner may be used as the decolorable toner as long as it has the characteristics described above. For example, a coloring agent of the decolorable toner may be a leuco dye. The decolorable toner may be appropriate combination of a developer, a decolorzing agent, a discoloration temperature adjusting agent and the like.

A fixing temperature of the decolorable toner is lower than a fixing temperature of the non-decolorable toner. Herein, the fixing temperature of the decolorable toner refers to a temperature of a heat roller (not shown) in a decolorable toner mode described later. The fixing temperature of the non-decolorable toner refers to a temperature of the heat roller (not shown) in a monochrome toner mode described later.

The fixing temperature of the decolorable toner is lower than a temperature of the decoloring processing of the decolorable toner. The temperature of the decoloring processing of the decolorable toner refers to a temperature of the heat roller (not shown) in the decoloring mode described later.

Next, the printing section 4 is described in detail. The printing section 4 includes a transfer section 30 and the fixing section 40.

The transfer section 30 is provided with an exposure section. 31, the intermediate transfer body 32, a cleaning blade 33, image forming sections 34 and, 35, primary transfer rollers 36D and 36K, and the secondary transfer section 37. Hereinafter, in a case of not distinguishing the primary transfer rollers, the primary transfer rollers 36D and 36K are simply described as a primary transfer roller 36.

In FIG. 2, a reference numeral 38 represents a temperature detection section, and a reference numeral 39 represents a temperature adjustment section.

The temperature detection section 38 detects a temperature of the atmosphere around the secondary transfer section 37. For example, the temperature detection section 38 is a temperature sensor.

Based on a detection result of the temperature detection section 38, the temperature adjustment section 39 adjusts the temperature of the atmosphere around the secondary transfer section 37. For example, the temperature adjustment section 39 is a fan. The temperature adjustment section 39 may serve not only for adjusting the temperature of the atmosphere around the secondary transfer section 37 but also for exhausting ozone.

The transfer in the image forming apparatus 1 includes a first transfer process and a second transfer process.

In the first transfer process, the primary transfer roller 36 transfers images by the toner on photoconductive drums 34a and 35a of the image forming sections 34 and 35 onto the intermediate transfer body 32.

In the second transfer process, the secondary transfer section 37 transfers the toner image laminated on the intermediate transfer body 32 onto the sheet.

The scanner section 3 reads the image formed on the sheet which is a scanning object. For example, the scanner section. 3 reads the image on the sheet to generate the black (K) image data. The scanner section 3 outputs the generated image data. to an image processing section 8.

The image processing section 8 controls the exposure section 31 based on a black color signal.

The exposure section 31 irradiates (exposes) the photoconductive drums 34a and 35a of the image forming sections 34 and 35 with light

The schematic constitution of the exposure section 31 is described.

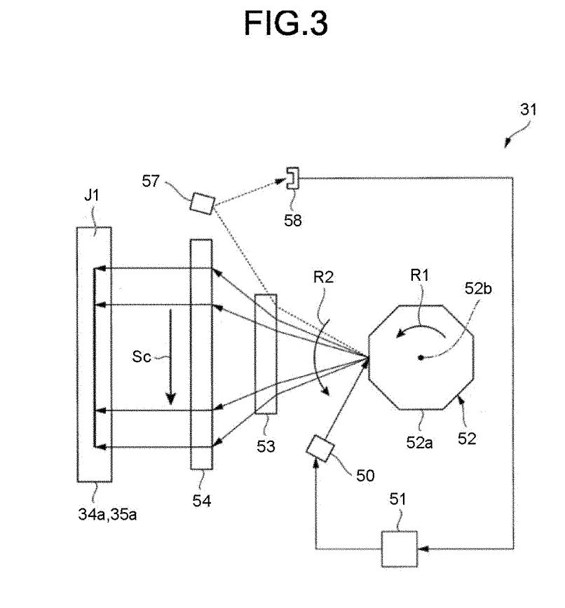

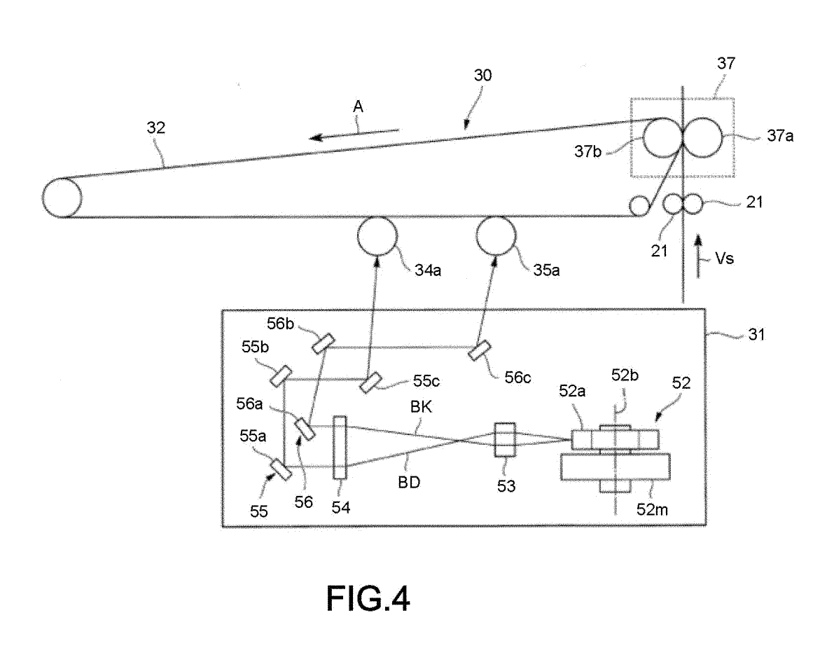

FIG. 3 is a plan view illustrating an example of a schematic constitution of an exposure section 31 according to one embodiment. FIG. 4 is a side view illustrating an example of a schematic constitution of an exposure section 31 according to one embodiment.

As shown in FIG. 3, the exposure section 31 includes a light source 50 (exposure light source), a light control circuit 51, a light deflection section 52, a first imaging lens 53, a second imaging lens 54, optical path change sections 55 and 56 (refer to FIG. 4), a mirror 57 and a sensor 58.

The light source 50 is an ED (Laser Diode) that emits a laser beam (light). The light source 50 may be an LED (Light Emitting Diode).

The light control circuit 51 includes a laser dryer for enabling the light source 50 to emit light. The light control circuit 51 outputs a laser beam optically modulated to the light source 50 based on an optical modulation signal. For example, the optical modulation signal is formed based on an image data signal and a horizontal synchronization signal. The laser beam emitted from the light source 50 becomes parallel light by changing a divergence angle with a collimator lens (not shown) and is incident on a reflection surface of a polygon mirror 52a at mutually different incident angles.

The light deflection section 52 includes the polygon mirror 52a of a regular polyhedral shape with a plane reflecting mirror (reflection surface) formed on an outer periphery thereof. The polygon mirror 52a rotates around a rotation axis 52b parallel to a sub-scanning axis by a motor 52m (refer to FIG. 4. The polygon mirror 52a rotates in an arrow R1 direction and deflects the laser beam at the same angular velocity in an arrow R2 direction on each reflection surface.

The polygon mirror 52a continuously reflects the laser beam from the light source 50 in an axial direction of the photoconductive drums 34a and 35a. The polygon mirror 52a continuously reflects the laser beam from the light source 50 in the same direction as a reading line at the time of image reading in the scanner section 3 (refer to FIG. 2). The laser beam reflected by the polygon mirror 52a is sequentially emitted to exposure positions on the outer peripheral surfaces of the photoconductive drums 34a and 35a via the first imaging lens 53 and the second imaging lens 54 in the axial direction of the photoconductive drums 34a and 35a.

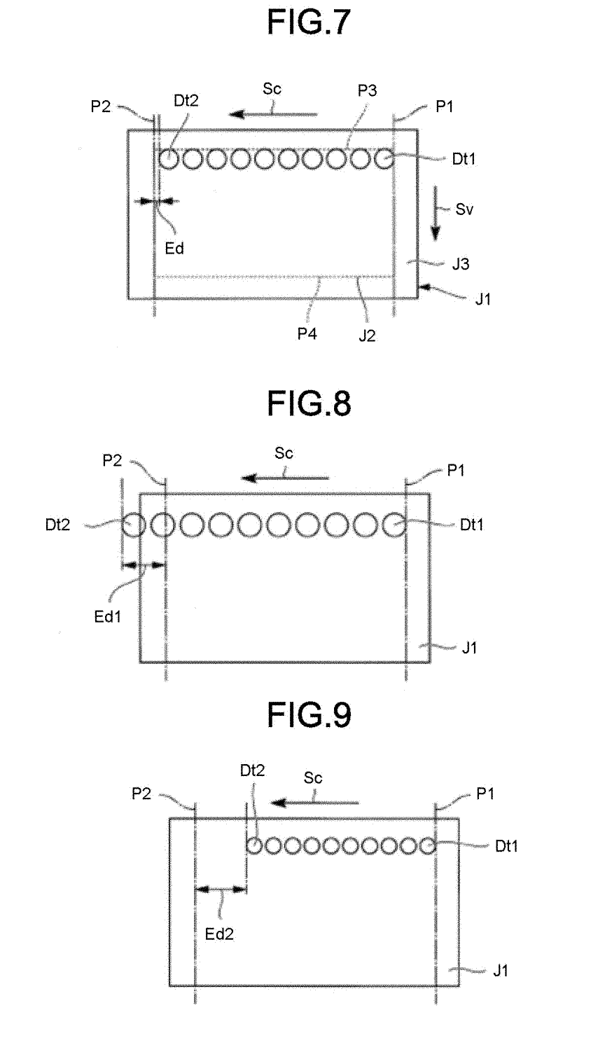

The first imaging lens 53 and the second imaging lens 54 impart predetermined optical characteristics to the laser beam reflected by the polygon mirror 52a. The first imaging lens 53 and the second imaging lens 54 extend in the axial direction. of the photoconductive drums 34a and 35a. The first imaging lens 53 and the second imaging lens 54 image the laser beam reflected by the polygon mirror 52a on the photoconductive drums 34a and 35a in such a manner that a relationship between an rotation angle and a focal length of the polygon mirror 52a satisfies an image height. The first imaging lens 53 and the second imaging lens 54 cooperate with a cylindrical lens (not shown) to converge the laser beam reflected by the polygon mirror 52a in the axial direction of the photoconductive drums 34a and 35a. In FIG. 3, the rotation axis each of the photoconductive drums 34a and 35a is a main scanning axis. The laser beam reflected by the polygon mirror 52a scans the surfaces of the photoconductive drums 34a and 35a along the main scanning axis. In FIG. 3, Sc is a main scanning direction, and the main scanning direction. Sc is parallel to the main scanning axis. The main scanning direction Sc is a direction in which the laser beam is deflected by the light deflection section 52. On the other hand, the sub-scanning direction Sv (refer to FIG. 7) is orthogonal to the main scanning axis. The sub-scanning direction Sv is parallel to a rotation axis 52b of the polygon mirror 52a.

As shown in FIG. 4, the optical path change sections 55 and 56 are arranged between the second imaging lens 54 and the photoconductive drums 34a and 35a.

The optical path change section 55 folds a laser beam BD for decoloring image forming section which passes through the second imaging lens 54 toward the photoconductive drum 34a. The optical path change section 55 has a plurality (only three mirrors are shown in FIG. 4) of mirrors 55a, 55b and 55c. The laser beam BD for decoloring image forming section which passes through the second imaging lens 54 is incident on the photoconductive drum 34a by reflection in the order of the mirrors 55a, 55b and 55c.

The optical path change section 56 folds the laser beam for non-decoloring (black) which passes through the second imaging lens 54 towards the photoconductive drum 35a. The optical path change section 56 has a plurality (only three mirrors are shown in FIG. 4) of mirrors 56a, 56b and 56c. A laser beam BK for non-decoloring image forming section which passes through the second imaging lens 54 is incident on the photoconductive drum 35a by reflection in the order of the mirrors 56a, 56b and 56c.

As shown in FIG. 3, the mirror 57 is arranged between the first imaging lens 53 and the sensor 58. The mirror 57 reflects the laser beam passing through the first imaging lens 53 towards the sensor 58.

The sensor 58 is arranged in an area, deviated from the photoconductive drums 34a and 35a, where the laser beam is scanned. The sensor 58 is arranged at the beginning side of the main scanning direction Sc. In other words, the sensor 58 is arranged at the side of the scanning start position of the laser beam in the main scanning direction Sc. The sensor 58 detects the laser beam scanning the scanning area J1 in order to synchronize the main scanning direction Sc in the scanning area J1.

The scanning area J1 refers to an area where the laser beam scans on the surfaces of the photoconductive drums 34a and 35a. The scanning start position refers to a start position of the scanning area J1 in the main scanning direction Sc. The scanning start position is arranged at the beginning (one end) of one scanning line (hereinafter, also referred to as “one line”) formed in the scanning area J1. The scanning termination position refers to a termination position at a side opposite to the scanning start position in the main scanning direction Sc. The scanning termination position is located at an end (the other end) of one line formed in the scanning area J1.

For example, the sensor 58 is a horizontal synchronous sensor. The sensor 58 inputs a horizontal synchronization signal for creating a switching timing of one line formed in the scanning area J1 to the light control circuit 51. The horizontal synchronization signal is used for notifying the termination of scanning of one line currently being scanned and the start of scanning of one line to be scanned next.

Based on the detection result of the sensor 58, the light control circuit 51 determines the timing to start outputting image data corresponding to one line formed in the scanning area J1. The light control circuit 51 determines the number of dots formed in the main scanning direction Sc based on the detection result of the sensor 58.

As shown in FIG. 2, the intermediate transfer body 32 is an endless belt. The intermediate transfer body 32 (hereinafter, also referred to as an “intermediate transfer belt 32”) rotates in an arrow A direction in FIG. 2. The toner image is formed on the surface of the intermediate transfer belt 32.

The cleaning blade 33 removes the toner adhering to the intermediate transfer belt 32. For example, the cleaning blade 33 is a plate-like member. For example, the cleaning blade 33 is made of resin such as urethane resin. For example, a beginning of the cleaning blade 33 is pressed against the intermediate transfer belt 32, and the toner on the intermediate transfer belt 32 is scraped off. Instead of the cleaning blade 33, a charged brush may contact with the intermediate transfer belt 32.

The image forming sections 34 and 35 form an image with toner of each color (two colors in an example shown in FIG. 2). The image forming sections 34 and 35 are arranged in order along the intermediate transfer belt 32.

The primary transfer roller 36 is used at the time of transferring the toner image formed by the image forming sections 34 and 35 onto the intermediate transfer belt 32.

The secondary transfer section 37 includes a secondary transfer roller 37a and a secondary transfer counter roller 37b. The secondary transfer section 37 transfers the toner image formed on the intermediate transfer belt 32 onto the sheet. The controller 101 (refer to FIG. 5) can control a rotation speed of the secondary transfer roller 37a.

In the secondary transfer section 37, the intermediate transfer belt 32 contacts with the secondary transfer roller 37a. In terms of improving a paper lam, the intermediate transfer belt 32 and the secondary transfer roller 37a may be constituted to be capable of separating from each other.

The fixing section 40 fixes the toner image on the sheet by applying heating and pressure to the toner image transferred onto the sheet. For example, the fixing section 40 includes a heat roller (heating section) and a pressure unit (pressure section). The sheet on which the image is fixed by the fixing section 40 is discharged from the sheet discharge section 7 to the outside of the apparatus.

Next, the image forming sections 34 and 35 are described. The image forming section 34 transfers a decolorable toner image formed by the decolorable toner having a decoloring function onto the intermediate transfer belt 32. The image forming section 34 (hereinafter, also referred to as a “decoloring image forming section 34”) houses the decolorable toner. For example, the decolorable toner is blue toner.

The image forming section 35 is arranged at the downstream side of the decoloring image forming section 34 in the rotation direction. A of the intermediate transfer belt 32. The image forming section 35 transfers a non-decolorable toner image formed. by the non-decolorable toner that does not have the decoloring function onto the intermediate transfer belt 32. In one embodiment, the image forming section 35 (hereinafter, also referred to as a “non-decoloring image forming section 35”) houses a non-decoloring black toner.

The decoloring image forming section 34 and the non-decoloring image forming section 35 have the same constitution although the toner housed therein is different. Thus, the decoloring image forming section 34 is described on behalf of the image forming sections 34 and 35, and the description of the non-decoloring image forming section 35 is omitted.

The decoloring image forming section 34 includes a photoconductive drum 34a, a developing device 34b, a charging device 34c and a cleaning blade 34d.

The photoconductive drum 34a is a concrete example of an image carrier (image carrying module). The photoconductive drum 34a has a photoreceptor (photoconductive area) on an outer peripheral surface thereof. For example, the photoreceptor is an organic photoconductor (OPC).

The developing device 34b houses a developer. The developer contains the toner. The developing device 34b enables the toner to adhere to the photoconductive drum 34a. For example, the toner is used as a one-component developer or as a two-component developer in combination with a carrier. For example, an iron powder or a polymer ferrite particle having a particle diameter of several tens μm is used as the carrier. In one embodiment, a two-component developer containing a non-magnetic toner is used.

The charging device 34c uniformly charges the surface of the photoconductive drum 34a.

The cleaning blade 34d removes the toner attached to the photoconductive drum 34a.

The outline of the operation of the decoloring image forming section 34 is described.

The photoconductive drum 34a is charged to a predetermined potential by the charging device 34c. Next, the light is emitted from the exposure section 31 to the photoconductive drum 34a. Then, the potential of an area irradiated with the light in the photoconductive drum 34a changes. Due to the change in potential, an electrostatic latent image is formed on the surface of the photoconductive drum 34a. The electrostatic latent image on the surface of the photoconductive drum 34a is developed by the developer in the developing device 34b. On the surface of the photoconductive drum 34a, an image developed. by the toner (hereinafter referred to as a “developed image”) is formed.

The developed image formed on the surface of the photoconductive drum 34a is transferred onto the intermediate transfer belt 32 by the primary transfer roller 36D facing the photoconductive drum 34a (first transfer process).

By the operation of the decoloring image forming section. 34, an image only using the decolorable toner is formed. In other words, by the operation of the decoloring image forming section 34, the developed image only using the decolorable toner is formed on the intermediate transfer belt 32.

On the other hand, if the non-decoloring image forming section. 35 operates, the developed image only using the non-decolorable toner is formed on the intermediate transfer belt 32. In other words, by the operation of the non-decoloring image forming section 35, the developed image only using the non-decolorable toner is formed on the intermediate transfer belt 32. In the non-decoloring image forming section 35 shown in FIG. 2, a reference numeral 35a represents a photoconductive drum, a reference numeral 35b represents a developing device, a reference numeral 35c represents a charging device, and a reference numeral 35d represents a cleaning blade.

The second transfer process is described.

A voltage (bias) is applied to the secondary transfer counter roller 37b. Thus, an electric field is generated between the secondary transfer counter roller 37b and the secondary transfer roller 37a. By the electric field, the secondary transfer section 37 transfers the developed image formed on the intermediate transfer belt 32 onto the sheet. The sheet onto which the developed image is transferred is guided by a guide 60 towards the fixing section 40.

Next, a type of an image forming processing executed by the image forming apparatus 1 (refer to FIG. 1) of one embodiment. is described. The image forming apparatus 1 executes a printing in two modes shown below.
monochrome toner mode: forming an image with non-decoloring black toner.
decolorable toner mode: forming an image only with the decolorable toner.

Which mode is used to execute the image forming operation can be selected by a user operating the operation and display section 2 (refer to FIG. 1) of the image forming apparatus 1.

In the monochrome toner mode, the non-decoloring image forming section 35 (refer to FIG. 2) using the non-decoloring black (K) toner operates to form an image. The monochrome toner mode is selected if the user desires to print a general monochrome image. For example, the monochrome toner mode is used in a case of keeping important data and the tike without reusing the paper.

In the decolorable toner mode, only the decoloring image forming section 34 (refer to FIG. 2) using the decolorable toner operates to form an image. The decolorable toner mode is selected in a case of reusing a paper on which the image is formed.

The fixing section 40 is controlled in the fixing mode and the decoloring mode. In the fixing mode, the toner image is fixed on the sheet. In the decoloring mode, the toner image is decolorized from the sheet. In the decoloring mode, the temperature of the heat roller (not shown) is higher than that in the fixing mode. The controller 101 (refer to FIG. 5) operates the fixing section 40 in at least two target temperatures. Specifically, two target temperatures of the fixing section 40 are stored in a memory 104 described later. The controller 101 extracts the target temperature from the memory 104 in response to the selected mode to operate the fixing section 40. The two target temperatures include a first temperature and a second temperature. The first temperature is a temperature at the time of the decoloring mode. The second temperature is a temperature at the time of the fixing mode. The second temperature is lower than the first temperature. The operation and display section 2 shown in FIG. 1 includes a button 12a (refer to FIG. 5, the operation section 12) for switching the fixing section 40 from the decoloring mode to the fixing mode.

The functional components of the image forming apparatus 1 are described.

FIG. 5 is a block diagram illustrating an example of functional components of the image forming apparatus according to one embodiment.

As shown in FIG. 5, the functional sections of the image forming apparatus 1 are connected via a system bus line 100 to be capable of executing data communication.

The controller 101 controls the operation of each functional section of the image forming apparatus 1. The controller 101 executes various processing by executing a program. The controller 101 acquires an instruction input by the user from the operation and display section 2. The controller 101 executes a control processing based on the acquired instruction.

The controller 101 includes a sheet information acquisition section 110, a deviation amount calculation section 111 and a deviation amount correction section 112.

The sheet information acquisition section 110 acquires information relating to a sheet size. The number of dots in one line is determined depending on the type of the sheet size.

The deviation amount calculation section 111 calculates a deviation amount of the dot (hereinafter, also referred to as a “deviation amount”) in the main scanning direction Sc at the time of changing a main scanning magnification. The deviation amount calculation section 111 calculates the deviation amount based on a launch start position in the main scanning direction Sc and a launch termination position caused by change in the main scanning magnification.

The deviation amount correction section 112 corrects the deviation amount through changing the main scanning magnification based on the calculation result of the deviation amount calculation section 111.

A network interface 102 transmits and receives data to and from other devices. The network interface 102 operates as an input interface to receive the data transmitted from other devices. The network interface 102 also operates as an output interface to transmit the data to other devices.

A storage device 103 stores various data. For example, the storage device 103 is a hard disk or an SSD (Solid State Drive). For example, various data include digital data, screen data of a setting screen, setting information, a job, a job log and the like. The digital data is generated by the scanner section 3. The setting screen is a screen for executing a correction control on the deviation amount caused by change in the main scanning magnification. The setting information relates to the setting operation of the correction control on the deviation amount caused by change in the main scanning magnification.

The memory 104 temporarily stores data used by each functional section. For example, the memory 104 is a RAM (Random Access Memory). For example, the memory 104 temporarily stores the digital data, the lob, the job log and the like.

An example of the correction control on the deviation amount is described below.

The controller 101 executes the correction control on the deviation amount at the time of forming an image on the sheet.

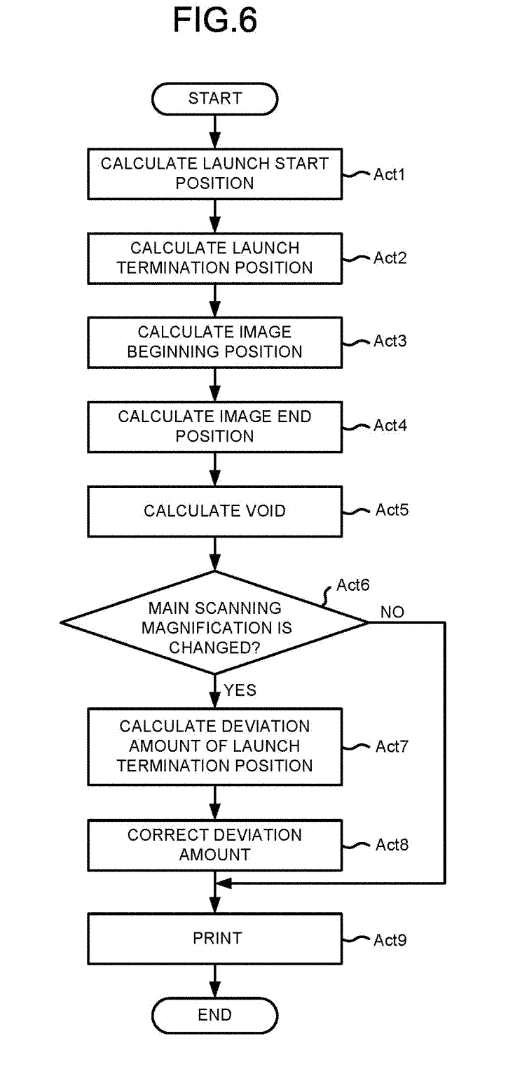

FIG. 6 is a flowchart illustrating an example of correction control on a deviation amount according to one embodiment.

FIG. 7 is a diagram illustrating an example of a scanning area J1 before a main scanning magnification is changed. In FIG. 7, a reference numeral J2 indicates a display area, and a reference numeral J3 indicates a void. The display area J2 refers to an area where dots (for example, black dots) for printing an image on the sheet (transferring the toner image) are formed in the scanning area J1. The void J3 refers to a blank area located on the outer periphery of the display area J2.

As shown in FIG. 6, in Act 1, the controller 101 calculates the launch start position. For example, the controller 101 calculates a print starting position P1 (refer to FIG. 7) 7) based on the information relating to the sheet size acquired by the sheet information acquisition section 110 (refer to FIG. 5) and the setting information in the display area J2. The launch start position refers to the scanning start position of the laser beam in the display area J2. The launch start position is an initial formation position of the dot (for example, black dot) in the main scanning direction Sc. In FIG. 7, a reference numeral Dt1 indicates the dot formed first in the main scanning direction Sc.

In Act 2, the controller calculates the launch termination. position. For example, the controller 101 calculates a print termination position P2 (refer to FIG. 7) based on the information relating to the sheet size acquired by the sheet information acquisition section 110 (refer to FIG. 5) and the setting information in the display area J2. The launch termination position refers to the scanning termination position of the laser beam in the display area J2. The launch termination position is a last formation position of the dot (for example, black dot) in the main scanning direction Sc. In FIG. 7, a reference numeral Dt2 indicates the dot formed last in the main scanning direction Sc.

In Act 3, the controller 101 calculates an image beginning position. The image beginning position refers to a position at which the laser beam is first launched in the display area J2 in the sub-scanning direction Sv. For example, the controller 101 calculates an image beginning position P3 (refer to FIG. 7) based on the information relating to the sheet size acquired by the sheet information acquisition section 110 (refer to FIG. 5) and the setting information in the display area J2.

In Act 4, the controller 101 calculates an image end position. The image end position refers to an end position at the side opposite to the image beginning position P3 in the sub-scanning direction SY. For example, the controller 101 calculates an image end position P4 (refer to FIG. 7) based on the information relating to the sheet size acquired by the sheet information acquisition section 110 (refer to FIG. 5) and the setting information in the display area J2.

In Act 5, the controller 101 calculates the void J3 (refer to FIG. 7). For example, the controller 101 calculates the void J3 based on the information relating to the sheet size acquired by the sheet information acquisition section 110 (refer to FIG. 5) and the setting information in the display area J2.

The calculation result of the controller 101 is stored in storage device 103. The information relating to the print. starting position P1, the print termination position P2, the image beginning position P3, the image end position P4 and the void J3 (refer to FIG. 7) is stored in the storage device 103.

At the time of the image formation, the position of the dot initially launched in the main scanning direction (hereinafter, also referred to as “start dot”) coincides with the launch start position. In addition, the position of the dot launched last in the main scanning direction (hereinafter also referred to as “end dot”) coincides with the launch termination position.

However, the arrangement position of the dot deviates from the reference position due to various factors in some cases.

For example, the factor of deviation of the arrangement position of the dot from the reference position is as follows.
(1) a wavelength of light is deviated due to temperature change.
(2) a positioning part inside the apparatus thermally expands.
(3) a distance between the optical element and the photoconductive drum changes due to the exchange of the photoconductive drum.

In FIG. 7, the position of the start dot Dt1 coincides with the print starting position P1 and the position of the end dot Dt2 deviates from the print termination position P2. In FIG. 7, a reference numeral Ed indicates the deviation amount between the end dot Dt2 and the print termination position P2.

For example, it is considered to change the main scanning magnification as a method of adjusting the arrangement position of the dot to an appropriate position. Changing the main scanning magnification refers to enlarging or reducing the main scanning magnification. For example, if the position of the start dot Dt1 matches the print starting position P1, it is considered to set the print starting position P1 as a change criterion of the main scanning magnification.

However, if the main scanning magnification with the print starting position P1 as a reference is changed, the arrangement. position of the dot excessively deviates from the reference position.

As the factor of excessive deviation of the arrangement position of the dot from the reference position, since the size of each dot is changed by changing the main scanning magnification, the degree of position deviation increases as the number of dots from the reference position increases. For example, if 7000 dots are placed in one line, the position deviation at the side of the launch termination position becomes prominent.

If the arrangement position of the dot deviates from the reference position due to the change of the main scanning magnification as well, as adjustment of the printing position is required again, there is a possibility that excessive workload is required.

FIG. 8 is a diagram illustrating an example of a scanning area J1 after a main scanning magnification is enlarged.

As shown in FIG. 8, if the main scanning magnification is enlarged according to the print starting position P1 as the reference, there is a possibility that the position of the end dot Dt2 deviates excessively towards the outside of the print termination position P2. In FIG. 8, a reference numeral Ed1 indicates a deviation amount between an end dot Dt2 and a print termination position P2.

If the position of the end dot Dt2 excessively deviates towards the outside of the print termination position P2, there is a possibility that the transfer position deviation of an image G (refer to FIG. 13) on a sheet F becomes conspicuous unless the printing position is readjusted.

FIG. 9 is a diagram illustrating an example of a scanning area 31 after a main scanning magnification is reduced.

As shown in FIG. 9, if the main scanning magnification is reduced on the basis of the print starting position P1, there is a possibility that the position of the end dot Dt2 excessively deviates towards the inside of the print termination position P2. In FIG. 9, a reference numeral Ed2 indicates the deviation amount between the end dot Dt2 and the print termination position P2.

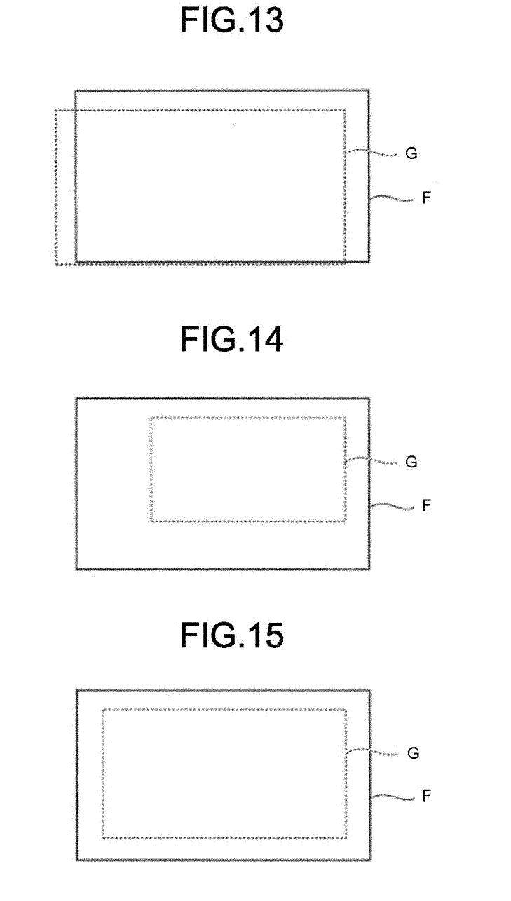

If the position of the end dot Dt2 excessively deviates towards the inside of the print termination position P2, there is a possibility that the transfer position deviation of the image G (refer to FIG. 14) on the sheet F becomes conspicuous unless the printing position is readjusted.

As shown in FIG. 13 and FIG. 14, in the case in which a position deviation of an image G on a sheet F is conspicuous, a process of adjusting the arrangement position of the dot to the appropriate position requires much workload in order to prevent the transfer position deviation of the image G on the sheet F from occurring.

In one embodiment, the following control is executed in order to prevent the transfer position deviation of the image on the sheet from occurring and to reduce the workload of the process of adjusting the arrangement position of the dot.

Based on the detection result of the sensor 58, the controller 101 corrects the deviation amount by setting the print termination position P2 of the laser beam in the main scanning direction Sc as the reference position. In addition, the controller 101 corrects the deviation amount at the time of changing the main scanning magnification. For example, the controller 101 determines that “the main scanning magnification is changed” if receiving the enlargement or reduction of the main scanning magnification.

In one embodiment, the sensor 58 is arranged at the side opposite to the reference position in the main scanning direction Sc. The sensor 58 is arranged at the side of the scanning start position of the laser beam in the main scanning direction Sc (refer to FIG. 3).

As shown in FIG. 6, in Act 6, if determining that “the main scanning magnification is not changed” (No in Act 6), the controller 101 proceeds to the processing Act 9. In Act 9, the controller 101 starts printing without correction control of deviation amount. For example, the controller 101 sets the image size printed on the sheet based on information relating to the print starting position P1, the print termination. position P2, the image beginning position P3, the image end position P4 and the void J3 (refer to FIG. 7) stored in the storage device 103.

On the other hand, in Act 6, if determining that “the main scanning magnification is changed” (Yes in Act 6), the controller 101 proceeds to the processing in Act 7. In Act 7, the deviation amount calculation section 111 (refer to FIG. 5 5) calculates the deviation amount if the main scanning magnification is changed. Specifically, the deviation amount calculation section 111 calculates the deviation amount based on the print starting position P1 (refer to FIG. 7) in the main scanning direction Sc and the launch termination position due to the change of the main scanning magnification.

The launch termination position due to the change of the main scanning magnification differs between a case of enlarging the main scanning magnification and a case of reducing the main scanning magnification. If the main scanning magnification is enlarged, the launch termination position is the position of the end dot Dt2 shown in FIG. 8. If the main scanning magnification is enlarged, the deviation amount becomes Ed1.

On the other hand, if the main scanning magnification is reduced, the launch termination position is the position of the end dot Dt2 in the main scanning direction Sc shown in No. 9. If the main scanning magnification is reduced, the deviation amount is Ed2.

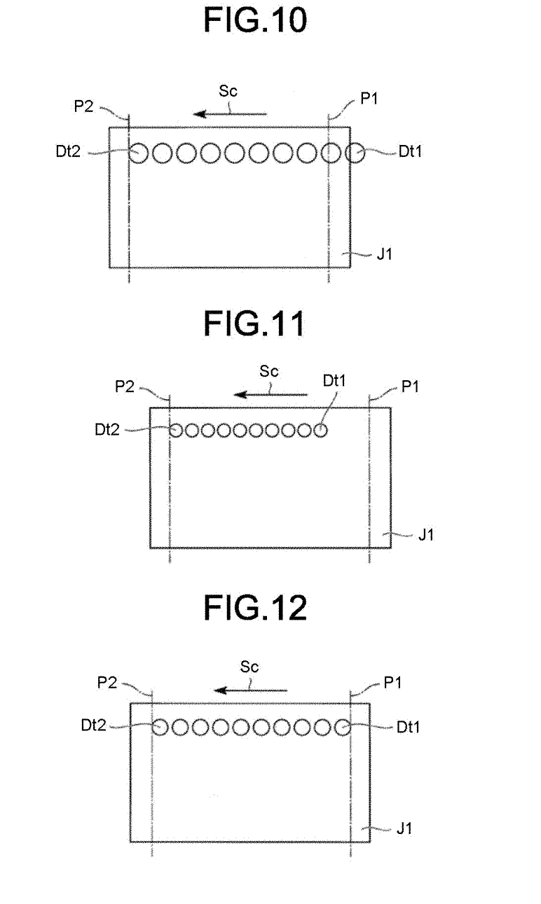

In Act 8, the deviation amount correction section 112 (refer to FIG. 5) corrects the deviation amount by changing the main scanning magnification based on the calculation result of the deviation amount calculation section 111. As shown in FIG. 10, if a main scanning magnification is enlarged, a deviation amount correction section 112 corrects the deviation amount by setting the print termination position P2 as the reference position in the main scanning direction Sc based on the detection result of the sensor 58. The position of the end dot Dt2 shown in FIG. 8 is coincident with the reference position. Next, as shown in FIG. 12, based on a deviation amount Edi (refer to FIG. 8) in a case of enlarging a main scanning magnification, the deviation amount correction section 112 executes correction by reducing the main. scanning magnification to eliminate the position. deviation of the dot in the main scanning direction Sc.

On the other hand, as shown in FIG. 11, if a main scanning magnification is reduced, a deviation amount correction section 112 also corrects the deviation amount by setting the print termination position P2 as the reference position in the main scanning direction Sc based on the detection result of the sensor 58. The position of the end dot Dt2 shown in FIG. 9 is coincident with the reference position. As shown in FIG. 12, based on the deviation amount Ede (refer to FIG. 9) in a case of reducing the main scanning magnification, the deviation amount correction section 112 executes correction by enlarging the main scanning magnification to eliminate the position deviation of the dot in the main scanning direction Sc.

After correcting the deviation amount, the flow proceeds to the processing in Act 9. In Act 9, the printing is started. Since the position deviation of the dot in the main scanning direction. Sc is eliminated after correcting the deviation amount, it is possible to prevent the transfer position deviation of the image G on the sheet F from occurring as shown in FIG. 15. In addition, the process of adjusting the arrangement position of the dot to the appropriate position is not required, and the workload of the process of adjusting the arrangement position of the dot can be reduced.

According to one embodiment, the image forming apparatus 1 has the sensor 58 and the controller 101. The sensor 58 is used to detect the laser beam scanning the scanning area J1 to synchronize the main scanning direction Sc in the scanning area J1. Based on the detection result of the sensor 58, the controller 101 corrects the deviation amount with the print termination position P2 in the main scanning direction Sc as the reference position. With the above constitution, the following effects are achieved. As a method of correcting the deviation amount, it is considered to set the print starting position Pi as the reference position. However, if the print starting position P1 is set as the reference position, there is a possibility that the arrangement position of the dot deviates because the laser beam is easily influenced by various factors before reaching the print termination position P2. According to one embodiment, by correcting the position deviation of the dot with the print termination position P2 at the side opposite to the print starting position P1 as the reference position in the main scanning direction Sc, as the laser beam is not affected by the various factors described above, it is possible to prevent the arrangement position of the dot from deviating. Therefore, it is possible to prevent the transfer position deviation of the image on the sheet from occurring and to reduce workload of the process of adjusting the arrangement position of the dot.

The sensor 58 is arranged at the opposite side to the reference position in the main scanning direction Sc, thereby achieving the following effects. The deviation of the arrangement position of the dot due to the change of the main scanning magnification becomes larger as compared with a case in which the sensor 58 is arranged at the reference position. side in the main scanning direction Sc, it is practical to prevent the occurrence of the position deviation of the image on the sheet and reduce the workload of the process of adjusting the arrangement position of dot.

The controller 101 has the following effects by correcting the deviation amount at the time of changing the main scanning magnification. By the way, if the main scanning magnification is changed on the basis of the print starting position P1, the size of each dot is changed due to the change of the main scanning magnification, so the degree of the position deviation increases from the reference position as the number of dots increases, and thus, there is a possibility that the arrangement position of the dot excessively deviates from the reference position. According to one embodiment, by correcting the position deviation of the dot with the print termination position P2 at the opposite side to the print starting position P1 as the reference position in the main scanning direction Sc, since it is not affected by the position deviation due to the change of the main scanning magnification, it is possible to prevent the deviation of the arrangement position of the dot. Therefore, according to one embodiment, even if the main scanning magnification is changed, it is possible to prevent the transfer position deviation of the image on the sheet from occurring and reduce the workload of the process of adjusting the arrangement position of the dot.

The controller 101 includes the deviation amount calculation section 111 and the deviation amount correction section 112. The deviation amount calculation section 111 calculates the deviation amount based on the print starting position P1 in the main scanning direction Sc and the launch termination position due to the change of the main scanning magnification. The deviation amount correction section 112 corrects the deviation amount by changing the main scanning magnification based on the calculation result of the deviation amount calculation section 111. With the above constitution, the following effects are achieved. As the deviation amount correction section 112 corrects the deviation amount by changing the main scanning magnification based on the deviation amount calculated by the deviation amount calculation section 111, it is possible to more effectively prevent deviation of the arrangement position of the dot. Therefore, it is possible to more effectively prevent the transfer position deviation of the image on the sheet from, occurring, and to more effectively reduce the workload of the process of adjusting the arrangement position of the dot.

The non-decoloring image forming section 35 is arranged at the downstream side of the decoloring image forming section 34 in the rotation direction A of the intermediate transfer belt 32, and the following effects are achieved. In the image forming apparatus 1 of the two-tandem type having only the decoloring image forming section 34 and the non-decoloring image forming section 35, it is possible to prevent the transfer position deviation of the image on the sheet from occurring, and to reduce the workload of the process of the adjusting step of the arrangement position.

There is a 4-tandem type of an image forming apparatus having four image forming stations of Y (yellow), M (magenta), C (cyan) and K (black). At YM (yellow and magenta) image forming stations, a sensor (hereinafter, referred to as an “YM side sensor”) for detecting light for YM is provided in order to synchronize the main scanning direction of the light for M. At CK (cyan and black) image forming stations, a sensor (hereinafter referred to as a “CK side sensor”) which detects the light for CK is provided in order to synchronize the main scanning direction of the light for CK. The image forming apparatus provided with four sets of image forming stations of YMCK is provided with the YM side sensor and the CR side sensor. The YM side sensor is arranged at the side of the scanning start position. in the main scanning direction of the light for YM. The CR side sensor is arranged at the side of the scanning start position in the main scanning direction of the light for CR. If two reference positions in the main scanning direction are set, as reconsideration of the device constitution is required or the manufacture becomes difficult, only one of the reference positions is set. For example, first, the reference position at the CR side is set based on The CR side sensor. Next, the reference position at the YR side is coincident with the reference position at the CK side. On the other hand, depending on the specification of the image forming apparatus, the YM side sensor and the CK side sensor are not provided and only one of the sensors are provided. If only one sensor is provided, depending on the arrangement position of the sensor, the arrangement position of the dot deviates from the reference position. If the arrangement position of the dot deviates from the reference position, the transfer position deviation of the image on the sheet may occur. According to one embodiment, even if only one sensor 58 is provided, the sensor 58 is arranged at the opposite side of the reference position in the main scanning direction Sc, and the following effect is achieved. The deviation of the arrangement position of the dot due to the change of the main scanning magnification becomes larger as compared with a case in which the sensor 58 is arranged at the side of the reference position in the main scanning direction Sc, it is practical to prevent the occurrence of position deviation and reduce the workload of the process of adjusting the arrangement position of the dot.

Hereinafter, modification is described. The transfer section 30 is not limited to having the decoloring image forming section 34 and the non-decoloring image forming section 35. For example, the transfer section 30 may have only either one of the decoloring image forming section 34 and the non-decoloring image forming section 35.

The non-decoloring image forming section 35 is not limited to being arranged at the downstream side with respect to the decoloring image forming section 34 in the rotation direction A of the intermediate transfer belt 32. The non-decoloring image forming section 35 may be arranged at the upstream side with respect to the decoloring image forming section 34 in the rotation direction A of the intermediate transfer belt 32.

The image forming apparatus 1 is not limited to executing the printing in two modes, i.e., the monochrome toner mode and the decolorable toner mode. For example, the image forming apparatus 1 may execute the printing only in the monochrome toner mode, or only in the decal arable toner mode. The image forming apparatus 1 may execute the printing in the color toner mode for forming an image with non-decoloring monochrome toner and color toner. Which mode among the monochrome toner mode, the color toner mode, and the decolorable toner mode is used to execute the image formation may be selected by the user through operating the operation and display section 2 of the image forming apparatus 1.

According to the image forming apparatus of at least one embodiment described above, it is possible to prevent the transfer position deviation of the image on the sheet from occurring and to reduce the workload of the process of adjusting the arrangement position of the dot.

The function of the image forming apparatus in one embodiment described above may be realized by a computer. In that case, it may be realized by recording a program for realizing the function in a computer-readable recording medium and enabling a computer system to read and execute the program recorded in the recording medium. The “computer system” mentioned above includes an OS or hardware such as peripheral devices. The “computer-readable recording medium” refers to a portable medium such as a flexible disk, a magneto-optical disk, a ROM, a CD-ROM and the like, or a storage device such as a hard disk built in the computer system. Furthermore, the “computer-readable recording medium” may also include a medium for dynamically holding the program for a short time, such as a communication wire for transmitting the program via a network such as an Internet or a communication line such as a telephone line, or a medium for holding the program for a certain time such as a volatile memory inside a computer system serving as a server or a client in that case. The program mentioned above may be used for realizing a part of the above-described functions, or may be used to realize the above-described function by a combination with a program already recorded in the computer system.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An image forming apparatus, comprising:
a sensor configured to detect a light for scanning a scanning area to synchronize a main scanning direction in the scanning area; and
a controller configured to correct a deviation amount of the main scanning direction by setting a launch termination position of the light in the main scanning direction as a reference position based on a detection result of the sensor.

2. The image forming apparatus according to claim 1, wherein
the sensor is arranged at an opposite side to the reference position in the main scanning direction.

3. The image forming apparatus according to claim 1, wherein
the controller corrects the deviation amount at a time when a main scanning magnification is changed.

4. The image forming apparatus according to claim 2, wherein
the controller corrects the deviation amount at a time when a main scanning magnification is changed.

5. The image forming apparatus according to claim 1, wherein the controller includes:
a deviation amount calculation section configured to calculate the deviation amount based on (a) a launch start position of the light in the main scanning direction and (b) the launch termination position due to change of the main. scanning magnification, and
a deviation amount correction section configured to correct the deviation amount by changing a main scanning magnification based on a calculation result of the deviation amount calculation section.

6. The image forming apparatus according to claim 1, further comprising:
an intermediate transfer body;
an decoloring image forming section configured to transfer a decolorable toner image formed by a decolorable toner having a decoloring function onto the intermediate transfer body; and
a non-decoloring image forming section, arranged at a downstream side of the decoloring image forming section in a rotation direction of the intermediate transfer body, configured to transfer a non-decolorable toner image formed with a non-decolorable toner having a non-decoloring function onto the intermediate transfer body.

7. The image forming apparatus according to claim 6, wherein the intermediate transfer body is an endless belt.

8. A method for controlling image transfer position. deviation, comprising:
detecting a light for scanning a scanning area to synchronize a main scanning direction in the scanning area; and
correcting a deviation amount of the main scanning direction by setting a launch termination position of the light in the main scanning direction as a reference position based on a detection result of the sensor.

9. The method for controlling image transfer position. deviation according to claim 8, further comprising:
arranging a sensor at an opposite side to the reference position in the main scanning direction.

10. The method for controlling image transfer position deviation according to claim 8, wherein the deviation amount is corrected at a time when a main scanning magnification is changed.

11. The method for controlling image transfer position deviation according to claim 9, wherein the deviation amount is corrected at a time when a main scanning magnification is changed.

12. The method for controlling image transfer position deviation according to claim 8, wherein the deviation amount is calculated based on (a) a launch start position of the light in the main scanning direction and (b) the launch termination position due to change of the main scanning magnification, and wherein the deviation amount is corrected by changing a main scanning magnification based on the calculated deviation amount

13. The method for controlling image transfer position deviation according to claim 8, further comprising:
transferring a decolorable toner image formed by a decolorable toner having a decoloring function onto an intermediate transfer body; and
transferring a non-decolorable toner image formed with. a non-decolorable toner having a non-decoloring function onto the intermediate transfer body.

14. The method for controlling image transfer position deviation according to claim 13, wherein the intermediate transfer body is an endless belt.
